(19) United States
(12) Patent Application Publication
(10) Pub. No.: US 2025/0187554 A1
(43) Pub. Date: Jun. 12, 2025

(54) ONBOARD DEVICE, CENTER DEVICE, STORAGE MEDIUM STORING VEHICLE CONTROL PROGRAM, AND VEHICLE CONTROL METHOD

(71) Applicant: DENSO CORPORATION, Kariya-city (JP)

(72) Inventors: Yusuke KANI, Kariya-city (JP); Yoshitaka TANEMURA, Kariya-city (JP); Satoshi NIWA, Kariya-city (JP)

(21) Appl. No.: 19/063,028

(22) Filed: Feb. 25, 2025

Related U.S. Application Data
(63) Continuation of application No. PCT/JP2023/032529, filed on Sep. 6, 2023.

(30) Foreign Application Priority Data
Sep. 13, 2022 (JP) 2022-145318

(51) Int. Cl. B60R 16/023; H04W 4/48

(52) U.S. Cl. CPC B60R 16/0231; H04W 4/48

(57) ABSTRACT

An onboard device mounted on a vehicle is configured to receive an operation request for the vehicle according to execution of application software and a first cancellation condition, which is a condition for canceling the operation request, from an application execution unit configured to execute the application software; store the operation request in a first queue; determine whether to cancel the operation request stored in the first queue according to the first cancellation condition and a second cancellation condition, which is a preset condition related to usage of the vehicle, for canceling the operation request; and delete the operation request from the first queue when it is determined that the operation request is to be canceled.

### CROSS REFERENCE TO RELATED APPLICATION

The present application is a continuation application of International Patent Application No. PCT/JP2023/032529 filed on Sep. 6, 2023 which designated the U.S. and claims the benefit of priority from Japanese Patent Application No. 2022-145318 filed on Sep. 13, 2022. The entire disclosures of all of the above applications are incorporated herein by reference.

### TECHNICAL FIELD

The present disclosure relates to vehicle control.

### BACKGROUND

A vehicle arbitration system described in a related art executes the arbitration of allocation of multiple requests to multiple application execution units and the arbitration within each execution unit to realize multiple requests from multiple application execution units.

### SUMMARY

An onboard device mounted on a vehicle is configured to receive an operation request for the vehicle according to execution of application software and a first cancellation condition, which is a condition for canceling the operation request, from an application execution unit configured to execute the application software; store the operation request in a first queue; determine whether to cancel the operation request stored in the first queue according to the first cancellation condition and a second cancellation condition, which is a preset condition related to usage of the vehicle, for canceling the operation request; and delete the operation request from the first queue when it is determined that the operation request is to be canceled.

### BRIEF DESCRIPTION OF DRAWINGS

Objects, features and advantages of the present disclosure will become more apparent from the following detailed description made with reference to the accompanying drawings. In the drawings:

FIG. 1 is a block diagram showing the schematic configuration of a vehicle control system according to an embodiment;

FIG. 2 is a block diagram showing the configuration of an ECU according to an embodiment;

FIG. 3 is a block diagram showing the configuration of a center according to an embodiment;

FIG. 4 is a block diagram showing some functions of the vehicle control system according to an embodiment;

FIG. 5 is a sequence diagram showing the flow of control processing executed in the vehicle control system according to an embodiment;

FIG. 6 is a diagram showing the cancellation conditions set by the application execution unit and the vehicle API according to an embodiment;

FIG. 7 is a block diagram showing another example of the schematic configuration of the vehicle control system according to an embodiment;

FIG. 8 is a block diagram showing another example of some functions of the vehicle control system according to an embodiment;

FIG. 9A is a sequence diagram showing a part of another example of the flow of control processing executed in the vehicle control system according to an embodiment; and

FIG. 9B is a sequence diagram showing the remaining part of another example of the flow of control processing executed in the vehicle control system according to an embodiment.

### DESCRIPTION OF EMBODIMENTS

If the vehicle arbitration system only responds to requests from an onboard device, there would be fewer duplicate requests, and multiple requests could be arbitrated immediately. However, in the future, it is anticipated that the vehicle arbitration system will receive a vast number of requests not only from onboard devices but also from external devices such as a center using APIs. As the number of requests increases, communication delays expand, and it becomes necessary to store requests waiting for processing. However, as a result of the inventors' detailed examination, it has been found that since the vehicle's situation changes from time to time, by the time the processing wait state of a request ends, the execution of that request may not be suitable for the vehicle's situation. Consequently, as a result of the inventors' detailed examination, it has been found that unnecessary requests might be executed, causing discomfort to the user.

One aspect of the present disclosure provides a technology capable of realizing vehicle control that does not cause discomfort to the user.

An onboard device according to one aspect of the present disclosure is mounted on a vehicle and includes a request acceptance unit, a request storage unit, a stored request cancellation determination unit, and a stored request deletion unit. The request acceptance unit is configured to receive an operation request for the vehicle according to the execution of application software and a first cancellation condition, which is a condition for canceling the operation request, from an application execution unit configured to execute the application software. The request storage unit is configured to store the operation request received by the request acceptance unit in a first queue. The stored request cancellation determination unit is configured to determine whether to cancel the operation request stored in the first queue according to the first cancellation condition received by the request acceptance unit and a second cancellation condition, which is a preset condition related to the usage of the vehicle, for canceling the operation request. The stored request deletion unit is configured to delete the operation request from the first queue when the stored request cancellation determination unit determines that the operation request is to be canceled.

An onboard device according to one aspect of the present disclosure receives an operation request and a first cancellation condition from the application execution unit. The onboard device then determines whether to cancel the operation request stored in the first queue according to the first cancellation condition received from the application execution unit and a second cancellation condition related to the usage of the vehicle when the waiting state for the operation request ends. The operation request determined to be canceled is deleted from the first queue. Therefore, it is possible to avoid executing operation requests that have become unnecessary during the waiting state. Consequently, vehicle control can be achieved without causing discomfort to the user.

A center device according to another aspect of the present disclosure is configured to communicate wirelessly with a vehicle and includes a request acceptance unit, a request storage unit, a stored request cancellation determination unit, and a stored request deletion unit. The request acceptance unit is configured to receive an operation request for the vehicle according to the execution of application software and a first cancellation condition, which is a condition for canceling the operation request, from an application execution unit configured to execute the application software. The request storage unit is configured to store the operation request received by the request acceptance unit in a first queue. The stored request cancellation determination unit is configured to determine whether to cancel the operation request stored in the first queue according to the first cancellation condition received by the request acceptance unit and a second cancellation condition, which is a preset condition related to the usage of the vehicle, for canceling the operation request. The stored request deletion unit is configured to delete the operation request from the first queue when the stored request cancellation determination unit determines that the operation request is to be canceled.

The center device according to another aspect of the present disclosure provides the same effects as the onboard device described above.

A vehicle control program according to another aspect of the present disclosure causes a processing device to execute: receiving an operation request for the vehicle according to the execution of application software and a first cancellation condition, which is a condition for canceling the operation request, from an application execution unit configured to execute the application software; storing the received operation request in a queue; determining whether to cancel the operation request stored in the queue according to the first cancellation condition and a second cancellation condition, which is a preset condition related to the usage of the vehicle, for canceling the operation request; and deleting the operation request from the queue when it is determined that the operation request is to be canceled.

By executing the vehicle control program according to another aspect of the present disclosure, the processing device achieves the same effects as the onboard device described above.

A vehicle control method according to another aspect of the present disclosure is executed by a processing device. The vehicle control method includes: receiving an operation request for the vehicle according to the execution of application software and a first cancellation condition, which is a condition for canceling the operation request, from an application execution unit configured to execute the application software; storing the received operation request in a queue; determining whether to cancel the operation request stored in the queue according to the first cancellation condition and a second cancellation condition, which is a preset condition related to the usage of the vehicle, for canceling the operation request; and deleting the operation request from the queue when it is determined that the operation request is to be canceled.

By executing the vehicle control method according to another aspect of the present disclosure, the processing device achieves the same effects as the onboard device described above.

A vehicle control program according to yet another aspect of the present disclosure causes a center device configured to communicate wirelessly with a vehicle to execute: receiving an operation request for the vehicle according to the execution of application software and a first cancellation condition, which is a condition for canceling the operation request, from an application execution unit configured to execute the application software; storing the received operation request in a queue; determining whether to cancel the operation request stored in the queue according to the first cancellation condition and a second cancellation condition, which is a preset condition related to the usage of the vehicle, for canceling the operation request; and deleting the operation request from the queue when it is determined that the operation request is to be canceled.

By executing the vehicle control program according to yet another aspect of the present disclosure, the center device achieves the same effects as the onboard device described above.

A vehicle control method according to yet another aspect of the present disclosure is executed by a center device configured to communicate wirelessly with a vehicle. The vehicle control method includes: receiving an operation request for the vehicle according to the execution of application software and a first cancellation condition, which is a condition for canceling the operation request, from an application execution unit configured to execute the application software; storing the received operation request in a queue; determining whether to cancel the operation request stored in the queue according to the first cancellation condition and a second cancellation condition, which is a preset condition related to the usage of the vehicle, for canceling the operation request; and deleting the operation request from the queue when it is determined that the operation request is to be canceled.

By executing the vehicle control method according to yet another aspect of the present disclosure, the center device achieves the same effects as the onboard device described above.

A vehicle control system according to another aspect of the present disclosure includes a first onboard device and a second onboard device mounted on a vehicle, and a center device configured to communicate wirelessly with the first onboard device. The center device includes a first request acceptance unit, a first request storage unit, a first stored request cancellation determination unit, and a first stored request deletion unit. The first request acceptance unit is configured to receive an operation request for the vehicle according to the execution of first application software and a first cancellation condition, which is a condition for canceling the operation request, from a first application execution unit configured to execute the first application software. The first request storage unit is configured to store the operation request received by the first request acceptance unit in a first queue. The first stored request cancellation determination unit is configured to determine whether to cancel the operation request stored in the first queue according to the first cancellation condition received by the first request acceptance unit and a second cancellation condition, which is a preset condition related to the usage of the vehicle, for canceling the operation request. The first stored request deletion unit is configured to delete the operation request from the first queue when the first stored request cancellation determination unit determines that the operation request is to be canceled.

The first onboard device includes a second request acceptance unit, a second request storage unit, a second stored request cancellation determination unit, and a second stored request deletion unit. The second request acceptance unit is configured to receive the operation request and the first cancellation condition determined not to be canceled by the first stored request cancellation determination unit. The second request storage unit is configured to store the operation request received by the second request acceptance unit in a second queue. The second stored request cancellation determination unit is configured to determine whether to cancel the operation request stored in the second queue according to the first cancellation condition received by the second request acceptance unit and the preset second cancellation condition. The second stored request deletion unit is configured to delete the operation request from the second queue when the second stored request cancellation determination unit determines that the operation request is to be canceled.

The second onboard device includes a request arbitration unit, an arbitration waiting request cancellation determination unit, and an arbitration waiting request deletion unit. The request arbitration unit is configured to store the operation request, which is determined not to be canceled by the second stored request cancellation determination unit, in a third queue and to arbitrate between the operation request and a competing request stored in the third queue. The arbitration waiting request cancellation determination unit is configured to determine whether to cancel the operation request according to the first cancellation condition and the second cancellation condition. The arbitration waiting request deletion unit is configured to delete the operation request from the third queue when it is determined by the arbitration waiting request cancellation determination unit that the operation request is to be canceled.

According to the vehicle control system, even if the processing wait time for the operation request becomes long in the center device, it is possible to avoid executing operation requests that have become unnecessary during the processing wait state. Consequently, vehicle control can be achieved without causing discomfort to the user.

A vehicle control method according to yet another aspect of the present disclosure is executed by a system comprising a first onboard device and a second onboard device mounted on a vehicle, and a center device configured to communicate wirelessly with the first onboard device. The center device receives an operation request for the vehicle according to the execution of first application software and a first cancellation condition, which is a condition for canceling the operation request, from a first application execution unit configured to execute the first application software, stores the received operation request in a first queue, determines whether to cancel the operation request stored in the first queue according to the first cancellation condition received and a second cancellation condition, which is a preset condition related to the usage of the vehicle, for canceling the operation request, and deletes the operation request from the first queue when it is determined that the operation request is to be canceled.

The first onboard device receives the operation request and the first cancellation condition determined not to be canceled by the center device, stores the received operation request in a second queue, determines whether to cancel the operation request stored in the second queue according to the first cancellation condition received and the preset second cancellation condition, and deletes the operation request from the second queue when it is determined that the operation request is to be canceled.

The second onboard device receives the operation request determined not to be canceled by the first onboard device, stores it in a third queue, arbitrates between the operation request and a competing request stored in the third queue, determines whether to cancel the operation request according to the first cancellation condition and the second cancellation condition, and deletes the operation request from the third queue when it is determined that the operation request is to be canceled.

By executing the vehicle control method according to yet another aspect of the present disclosure, the system achieves the same effects as the vehicle control system described above.

### 1. Configuration

### (1-1. System Configuration)

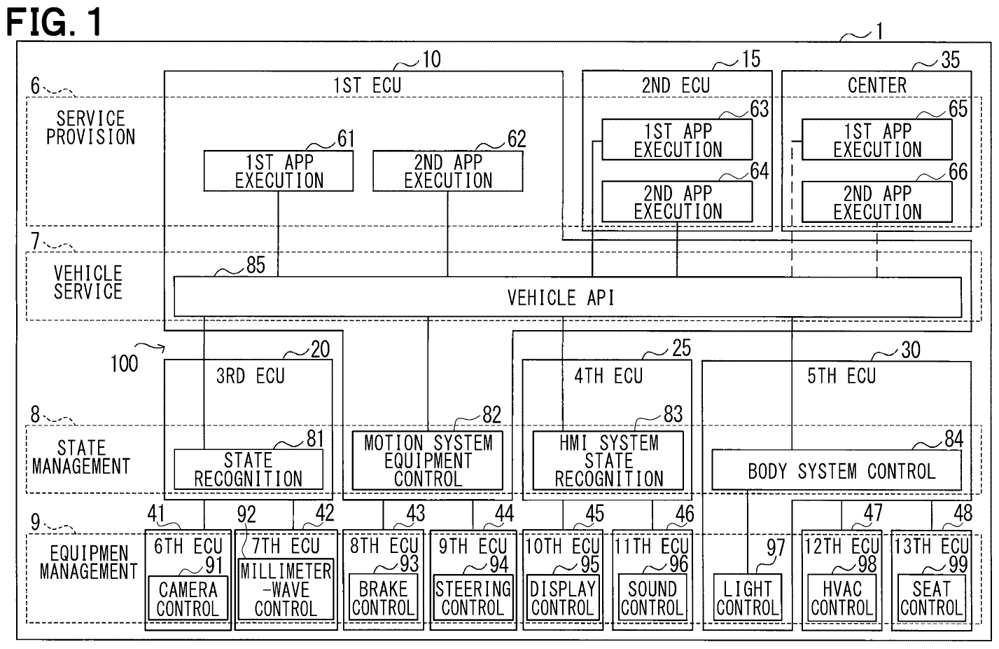

Referring to FIG. 1, the vehicle control system 1 according to this embodiment will be described. The vehicle control system 1 includes an electronic control unit group (hereinafter referred to as ECU group) 100 mounted on a vehicle such as an automobile, and a center 35. The ECU group 100 includes multiple ECUs. In this embodiment, the ECU group 100 includes a first ECU 10, a second ECU 15, a third ECU 20, a fourth ECU 25, a fifth ECU 30, and sixth to thirteenth ECUs 41 to 48. Each of the ECUs in the ECU group 100 is connected to each other via in-vehicle communication (i.e., wired or wireless communication). The center 35 is provided outside the vehicle and is connected to the ECU group 100 via external communication (i.e., wireless communication).

Each of the ECUs in the ECU group 100 and the center 35 controls target equipment, which is the subject of operation requests, among the equipment mounted on the vehicle. Here, the equipment may include hardware such as a sensor and an actuator, as well as software that realizes certain functions.

In another embodiment, the vehicle control system 1 may include the ECU group 100 without including the center 35. Additionally, in another embodiment, the ECU group 100 may include more than 14 ECUs or fewer than 13 ECUs.

### (1-2. Hardware Configuration)

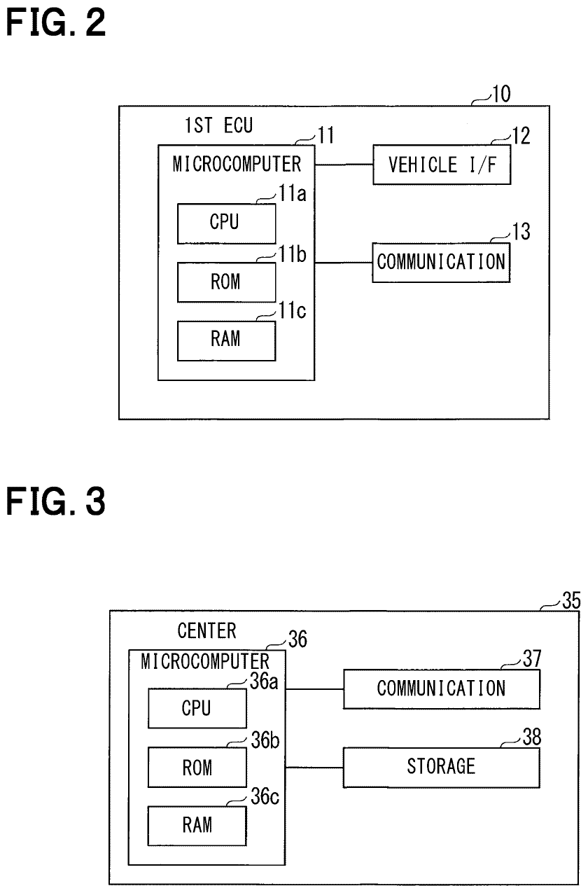

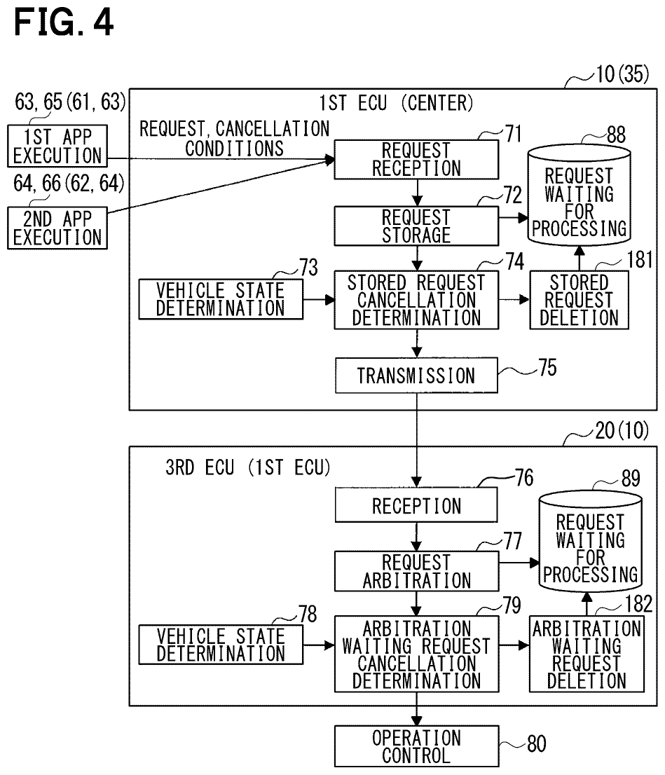

Next, referring to FIG. 2 and FIG. 3, the hardware configuration of the ECU group 100 and the center 35 will be described.

Each of the ECUs in the ECU group 100 has a similar hardware configuration. Therefore, the configuration of the first ECU 10 will be described as a representative example. The first ECU 10 includes a microcomputer 11, a vehicle interface (hereinafter referred to as I/F) 12, and a communication unit 13. The microcomputer 11 includes a CPU 11a, a ROM 11b, and a RAM 11c. Various functions of the first ECU 10 are realized by the CPU 11a executing a program stored in a non-transitory tangible storage medium. In this embodiment, the ROM 11b corresponds to the non-transitory tangible storage medium storing the program. Furthermore, by executing this program, the method corresponding to the program is executed.

The vehicle I/F 12 is connected to other ECUs and onboard devices via an in-vehicle network to acquire various information from other ECUs and onboard devices. The in-vehicle network may include a Controller Area Network (hereinafter referred to as CAN) and Ethernet. CAN is a registered trademark. Ethernet is a registered trademark.

The communication unit 13 performs data communication with the center 35 and other entities via a wide-area communication network through wireless communication. In another embodiment, only the first ECU 10 among the ECU group 100 may include the communication unit 13. Note that the methods for realizing various functions provided by the first ECU 10 are not limited to software, and some or all of the elements may be realized using one or more hardware components. For example, if the above functions are realized by electronic circuits as hardware, the electronic circuits may be realized by digital circuits including numerous logic circuits, analog circuits, or a combination of these.

The center 35 includes a microcomputer 36, a communication unit 37, and a storage unit 38. The microcomputer 36 includes a CPU 36a, a ROM 36b, and a RAM 36c. Various functions of the center 35 are realized by the CPU 36a executing a program stored in a non-transitory tangible storage medium. In this embodiment, the ROM 36b corresponds to the non-transitory tangible storage medium storing the program. Furthermore, by executing this program, the method corresponding to the program is executed.

The communication unit 37 performs data communication with the ECU group 100 via a wide-area communication network. The storage unit 38 is a storage device for storing vehicle data and other information provided by the ECU group 100. Note that the methods for realizing various functions provided by the center 35 are not limited to software, and some or all of the elements may be realized using one or more hardware components. For example, if the above functions are realized by electronic circuits as hardware, the electronic circuits may be realized by digital circuits including numerous logic circuits, analog circuits, or a combination of these.

### (1-3. Functional Configuration of the Entire System)

Returning to FIG. 1, the various functions provided by the vehicle control system 1 will be described. The vehicle control system 1 includes the functions of an equipment management unit 9 at the first layer, a state management unit 8 at the second layer, a vehicle service unit 7 at the third layer, and a service provision unit 6 at the fourth layer. The software architecture of the vehicle control system 1 is hierarchically structured into these four layers. These functions provided by the vehicle control system 1 are shared among each of the ECUs in the ECU group 100 and the center 35.

The equipment management unit 9 includes multiple control units corresponding to various types of vehicle equipment. Vehicle equipment includes, for example, in-vehicle cameras, in-vehicle millimeter-wave radars, brakes, steering, displays, speakers, various lights, in-vehicle air conditioners, and electric power seats.

Specifically, the equipment management unit 9 includes a camera control unit 91, a millimeter-wave control unit 92, a brake control unit 93, a steering control unit 94, a display control unit 95, a sound control unit 96, a light control unit 97, a Heating Ventilation and Air-Conditioning (hereinafter, HVAC) control unit 98, and a seat control unit 99. The vehicle equipment is individually controlled by the corresponding control units 91 to 99.

The camera control unit 91 controls the exposure and other settings of the in-vehicle camera to acquire images captured by the in-vehicle camera. The millimeter-wave control unit 92 controls the in-vehicle millimeter-wave radar to acquire detection results from the millimeter-wave radar. The brake control unit 93 controls the brakes. The steering control unit 94 controls the steering. The display control unit 95 controls displays (e.g., a meter, a warning light). The sound control unit 96 controls the speaker to output sounds such as warning sounds and voice. The light control unit 97 controls various lights mounted on the vehicle. The HVAC control unit 98 controls the in-vehicle air conditioner. The seat control unit 99 controls the electric power seats of the vehicle.

In this embodiment, the sixth ECU 41 includes the camera control unit 91, the seventh ECU 42 includes the millimeter-wave control unit 92, and the eighth ECU 43 includes the brake control unit 93. The ninth ECU 44 includes the steering control unit 94, the tenth ECU 45 includes the display control unit 95, and the eleventh ECU 46 includes the sound control unit 96. The fifth ECU 30 includes the light control unit 97, the twelfth ECU 47 includes the HVAC control unit 98, and the thirteenth ECU 48 includes the seat control unit 99.

The service provision unit 6 includes first application execution units 61, 63, 65 and second application execution units 62, 64, 66. Each of the first application execution units 61, 63, 65 and the second application execution units 62, 64, 66 executes different or the same application software (hereinafter, applications) to provide services to the user. Specifically, the service provision unit 6 provides services to the user by indirectly sending commands to the vehicle equipment to operate the vehicle equipment. The instructions include commands such as operation requests, commands such as arguments, and function calls. The commands may also include priority information indicating which command should be processed preferentially.

The applications executed by each of the first application execution units 61, 63, 65 and the second application execution units 62, 64, 66 are general-purpose programs that can be developed and widely published by third parties. Users can install applications published by third parties on any of the ECUs in the ECU group 100 via a wide-area communication network or other means. In other words, users can add or change applications.

In this embodiment, the first ECU 10, the second ECU 15, and the center 35 include the service provision unit 6. The first ECU 10 includes the first application execution unit 61 and the second application execution unit 62. The second ECU 15 includes the first application execution unit 63 and the second application execution unit 64. The center 35 includes the first application execution unit 65 and the second application execution unit 66. In one embodiment, the first ECU 10 and the third ECU 20 correspond to the onboard device of the present disclosure, with the first ECU 10 corresponding to the first device of the present disclosure and the third ECU 20 corresponding to the second device of the present disclosure. In another embodiment, the first ECU 10 corresponds to the onboard device of the present disclosure.

The vehicle service unit 7 includes a vehicle Application Programming Interface (hereinafter, API) 85. The vehicle API 85 executes processing adapted to specific vehicle models, specific grades, etc. That is, the vehicle API 85 executes processing that absorbs differences in vehicle models, grades, etc., so that the service provision unit 6 does not need to be aware of these differences. The vehicle API 85 corresponds to an API that adapts the commands handled by the service provision unit 6 to the commands handled by the state management unit 8 and the equipment management unit 9, which will be described later. In this embodiment, the first ECU 10 includes the vehicle service unit 7.

The equipment management unit 9 controls the vehicle equipment. Specifically, the state management unit 8 receives a first command via the vehicle API 85, generates a second command embodying the first command, and sends the second command to the equipment management unit 9. For example, the state management unit 8 calculates the operation amount of an actuator, which is one of the vehicle equipment, and sends a second command including the operation amount to the equipment management unit 9.

Specifically, the state management unit 8 selects the optimal control unit from the control units 91 to 99 provided by the equipment management unit 9 to realize the operation request (i.e., the first command) from the service provision unit 6. The state management unit 8 converts the first command into a second command in a format suitable for the selected control unit, considering the order of transmission, and distributes the second command to the selected control unit.

For example, if the first command is “turn the vehicle left at R200m while accelerating at 0.3G,” the state management unit 8 outputs a second command (i) requesting an output of 1000 Nm to the engine and a second command (ii) requesting an output of −0.1rad to the steering.

Additionally, if the first command is “transition to parking state,” the state management unit 8 outputs a second command (i) requesting the shift to P, a second command (ii) requesting the air conditioner to be turned off, a second command (iii) requesting the windows to be fully closed, and a second command (iv) requesting the doors to be locked and the vehicle to transition to the parking state once the requests (i) to (iii) are completed and the occupants have exited the vehicle.

The state management unit 8 includes a state recognition unit 81, a motion system equipment control unit 82, a Human Machine Interface (hereinafter, HMI) system state recognition unit 83, and a body system control unit 84, corresponding to the types of vehicle operations based on the types of first commands. The state recognition unit 81 acquires information from the camera control unit 91 and the millimeter-wave control unit 92, converts the acquired information into position information of vehicles and pedestrians, and outputs it to the vehicle API 85. The motion system equipment control unit 82 corresponds to vehicle operations such as turning, running, and stopping. The motion system equipment control unit 82 converts the vehicle operation requests into control amounts for the brake control unit 93 and the steering control unit 94 and outputs them. The state management unit 8 is classified by vehicle operations that the service provision unit 6 can easily request, rather than by implementation means (e.g., control units 91 to 99) that are more dependent on vehicle variations. For example, the state management unit 8 is provided corresponding to each domain of the vehicle.

The HMI system state recognition unit 83 corresponds to vehicle operations related to information presentation to the user. The HMI system state recognition unit 83 receives operation requests such as alarms, determines whether to perform notifications using the display control unit 95 and the sound control unit 96, and outputs control amounts. The body system control unit 84 receives first commands related to the vehicle environment and determines which of the light control unit 97, HVAC control unit 98, and seat control unit 99 to operate. The body system control unit 84 converts the first command into a second command suitable for the selected control unit and outputs it.

In this embodiment, the third ECU 20 includes the state recognition unit 81, the first ECU 10 includes the motion system equipment control unit 82, the fourth ECU 25 includes the HMI system state recognition unit 83, and the fifth ECU 30 includes the body system control unit 84.

Additionally, the state management unit 8 converts sensor data acquired from the equipment management unit 9 into a format suitable for the vehicle service unit 7 and sends the converted data to the vehicle service unit 7. Specifically, the state management unit 8 classifies individual raw sensor data acquired by the equipment management unit 9 from vehicle sensors into data by sensing targets that the service provision unit 6 can easily use. Furthermore, the state management unit 8 integrates the classified data, converts it into more abstract data, and sends the converted data to the vehicle service unit 7.

For example, the state management unit 8 acquires individual data such as vehicle speed 0 km/h, shift position P, and no driver in the vehicle from the equipment management unit 9, and based on the acquired data, generates data indicating that the vehicle is in a parking state. The state management unit 8 sends the generated data to the service provision unit 6 via the vehicle service unit 7.

Note that the distribution of functions of the vehicle control system 1 by each of the ECUs in the ECU group 100 and the center 35 may be appropriately changed. For example, the first ECU 10 may include the function of the state recognition unit 81 of the third ECU 20. In other words, the first ECU 10 and the third ECU 20 may be configured as a single ECU.

### (1-4. Functional Configuration of the Vehicle API and State Recognition Unit)

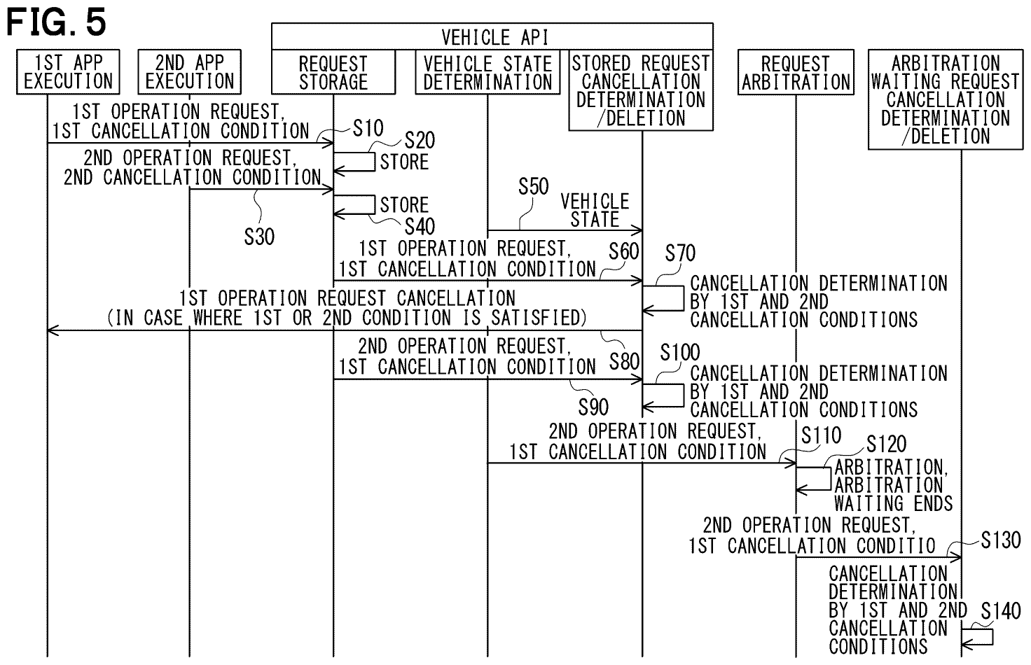

Next, referring to FIG. 4, an example of the detailed functions of the vehicle API 85 of the first ECU 10 and the state recognition unit 81 of the third ECU 20 will be described.

The vehicle API 85 includes the functions of a request reception unit 71, a request storage unit 72, a vehicle state determination unit 73, a stored request cancellation determination unit 74, a transmission unit 75, a stored request deletion unit 181, and a first queue 88.

The state recognition unit 81 includes the functions of a reception unit 76, a request arbitration unit 77, a vehicle state determination unit 78, an arbitration waiting request cancellation determination unit 79, an arbitration waiting request deletion unit 182, and a second queue 89.

The request reception unit 71 receives operation requests and first cancellation conditions from the first application execution units 63, 65 and the second application execution units 64, 66. The operation requests include identification information of the application execution unit that is the source of the request. The request storage unit 72 stores the operation requests in the first queue 88 each time the request reception unit 71 receives an operation request. The operation requests stored in the first queue 88 are in a processing waiting state.

The first cancellation condition is a condition for canceling the operation request and is specified for each operation request. The request storage unit 72 stores the first cancellation condition in association with the operation request. Additionally, the request storage unit 72 stores a second cancellation condition in advance in association with the operation request. Therefore, the request storage unit 72 stores the first cancellation condition and the second cancellation condition in association with the operation request. The second cancellation condition is a condition preset by the vehicle API 85. Details of the second cancellation condition will be described later.

After the request storage unit 72 receives an operation request, the state of the vehicle may change from time to time. The state of the vehicle includes, for example, the power state, battery state, driving state, and driving settings. The power state is the on or off state of the ignition. The battery state is the presence or absence of a voltage drop. The driving state is either parked, driving, or stopped. The driving settings are either autonomous driving or manual driving. Since the state of the vehicle may change from time to time, there is a possibility that the state of the vehicle may change while the operation request is in a processing waiting state in the first queue 88, making the execution of the operation request unnecessary or impossible by the time the processing waiting state ends.

For example, if there is a window opening/closing application that opens the window only when the ignition is on and closes the window when the ignition is off, an operation request to “open the window” may be stored in the first queue 88 and be in a waiting state while the ignition is on. In such a case, when the ignition is turned off, the window opening/closing application issues an operation request to “close the window.” If the previously issued “open the window” operation request remains in the first queue 88, the operation request to “open the window” is accepted once and then overwritten by the operation request to “close the window.” As a result, the window opens slightly and then closes, causing the user to feel discomfort with the window's behavior. Therefore, in such cases, it may be desirable for the operation request to “open the window” to be canceled when the ignition is turned off.

Accordingly, the first cancellation condition is set so that the operation request can be canceled when it becomes unnecessary or impossible. The first cancellation condition includes conditions related to the state of the vehicle. Specifically, when the state of the vehicle meets the first cancellation condition, the operation request is canceled. The state of the vehicle that meets the first cancellation condition includes states where the usage, operation, or behavior of the application may change. In other words, the state of the vehicle that meets the first cancellation condition includes states where the usage or operation of one piece of vehicle equipment may change.

The first cancellation condition for the operation request to “open the window” may include, in addition to or instead of the aforementioned ignition off, conditions such as driving at a speed of 80 km/h or higher or the wiper being on. When driving at a speed of 80 km/h or higher, the first application execution units 63, 65 and the second application execution units 64, 66 set the cancellation of the operation request to “open the window” to ensure safety. When the wiper is on, the first application execution units 63, 65 and the second application execution units 64, 66 set the cancellation of the operation request to “open the window” to prevent rain from entering the vehicle. Additionally, the first cancellation condition may include conditions unrelated to the state of the vehicle. For example, the first cancellation condition may be that three minutes have elapsed since the request storage unit 72 received the operation request.

Here, when a third party creates an application, the third party specifies the first cancellation condition, and the application execution unit executing the application created by the third party sets the first cancellation condition. The third party may not be familiar with the vehicle. In such cases, it is difficult for the third party to specify detailed cancellation conditions for specific states of the vehicle. Therefore, the platform provider presents multiple abstracted vehicle states as options. The abstracted vehicle states include, for example, (i) ignition on/off as an abstracted state of the power state, (ii) presence/absence of battery voltage drop as an abstracted state of the vehicle's battery voltage state, (iii) autonomous driving/manual driving as an abstracted state of the automation level, (iv) parked/driving/stopped as an abstracted state of the driving state, and (v) presence/absence of the driver in the vehicle. The third party selects the vehicle state from the presented options and specifies the cancellation condition for the selected vehicle state as the first cancellation condition.

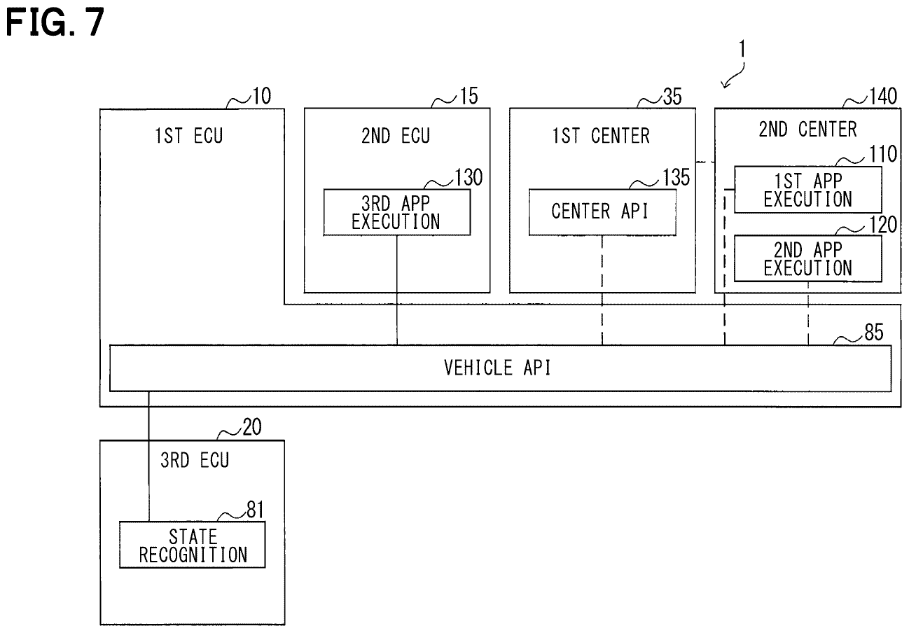

FIG. 6 shows examples of the first cancellation conditions, labeled as conditions A to E. Condition A is a cancellation condition based on a change in the power state (i.e., a change from ignition on to ignition off). Specifically, condition A is “cancel the operation request to open the window when changing from ignition on to ignition off, and allow the subsequent operation request to close the window.” The vehicle state that satisfies condition A is ignition off. Condition B is a cancellation condition based on the presence or absence of a battery voltage drop. Specifically, condition B is “cancel the operation request with a preset lower priority among multiple operation requests when multiple operation requests are issued by itself and information indicating a battery voltage drop is obtained.” The vehicle state that satisfies condition B is the presence of a battery voltage drop. By canceling the lower priority operation request based on condition B, the application execution unit can prolong the higher priority operation request among multiple operation requests.

Condition C is a cancellation condition based on a change in the automation level. Specifically, condition C is “cancel the operation request to change the seat position that is waiting in the first queue 88 or the second queue 89 when changing from autonomous driving to manual driving, and allow the operation request to move the seat to the driving position.” The vehicle state that satisfies condition C is the manual driving setting. Condition D is a cancellation condition based on a change in the driving state of the vehicle. Specifically, condition D is “cancel the operation request of an entertainment application that is waiting in the first queue 88 or the second queue 89 when changing from stopped to driving.” The vehicle state that satisfies condition D is driving. Condition E is a cancellation condition based on the presence or absence of the driver. Specifically, condition E is “cancel the operation request for meter display that is waiting in the first queue 88 or the second queue 89 when changing from driver present to driver absent.” The vehicle state that satisfies condition E is driver absent.

The vehicle state determination unit 73 determines the state of the vehicle.

The stored request cancellation determination unit 74 determines whether to cancel the operation request based on the vehicle state determined by the vehicle state determination unit 73 and the first cancellation condition and the second cancellation condition corresponding to the operation request stored in the first queue 88. The stored request cancellation determination unit 74 executes the cancellation determination when the processing waiting state of the operation request ends. Alternatively, the stored request cancellation determination unit 74 may execute the cancellation determination during the processing waiting state of the operation request. When executing the cancellation determination during the processing waiting state of the operation request, the stored request cancellation determination unit 74 may execute the cancellation determination only once or periodically.

The second cancellation condition includes cancellation conditions related to the state of the vehicle and is set by the vehicle API 85. That is, the second cancellation condition is set by the platform provider. The vehicle state that satisfies the second cancellation condition includes states where the usage or operation of the vehicle may change. Specifically, the vehicle state that satisfies the second cancellation condition includes states where the usage or operation of one or more pieces of vehicle equipment may change. The vehicle state where the usage or operation of one piece of vehicle equipment may change is the same as the vehicle state that satisfies the first cancellation condition. That is, the second cancellation condition includes the first cancellation condition and includes the aforementioned conditions A to E.

Additionally, the multiple pieces of vehicle equipment mentioned above correspond to a group of vehicle equipment that share the same vehicle resources. Vehicle resources include the vehicle's power supply (i.e., battery power), vehicle control amounts, processing load, communication volume, etc. The vehicle state where the usage or operation of multiple pieces of vehicle equipment may change is a state where the allocation of resources to at least one piece of equipment among the multiple pieces of vehicle equipment is reduced to avoid exceeding the threshold of resource usage.

For example, the second cancellation condition is to cancel both operation requests when receiving an operation request to turn on the first equipment and an operation request to turn on the second equipment in a vehicle state where the battery voltage is low. The first equipment is, for example, an air conditioner that uses battery power, and the second equipment is, for example, a front light that uses battery power.

Additionally, the second cancellation condition is to cancel both operation requests when receiving an operation request to increase the throttle opening and an operation request to increase the steering angle in a vehicle state where the driving control amount that satisfies both operation requests may cause the vehicle to deviate from the road.

Furthermore, the second cancellation condition includes cancellation conditions in situations where the application execution unit cannot set the cancellation condition. Situations where the application execution unit cannot set the cancellation condition include, for example, after the application execution has ended.

FIG. 6 shows examples of the second cancellation conditions, labeled as conditions F to H. Condition F is a cancellation condition based on a decrease in the vehicle's battery voltage. Specifically, condition F is “cancel the operation request with a power consumption above a predetermined value among the operation requests waiting in the first queue 88 or the second queue 89 when the battery voltage is low, and allow the operation request with a power consumption below the predetermined value.” Condition F is a condition related to the vehicle state where the usage or operation of multiple pieces of vehicle equipment may change. The vehicle state that satisfies condition F is a state where the battery voltage is low.

Condition G is a cancellation condition based on the control occupation by a specific application. Specifically, condition G is “cancel the operation requests of related applications waiting in the first queue 88 or the second queue 89 when remote autonomous driving starts to occupy vehicle control.” Condition G is a condition related to the vehicle state where the usage or operation of multiple pieces of vehicle equipment may change. The vehicle state that satisfies condition G is a state where remote autonomous driving is occupying vehicle control. Another example of condition G is “cancel all external operation requests waiting in the first queue 88 or the second queue 89 when prioritizing plug-in charging.” Another example of condition G is a condition related to the vehicle state where the usage or operation of multiple pieces of vehicle equipment may change. The vehicle state that satisfies condition G is a state where plug-in charging is prioritized.

Condition H is a cancellation condition based on the termination of the application. Specifically, condition H is “cancel the operation request waiting in the first queue 88 or the second queue 89 when the application has ended.” Note that conditions F, G, and H are used in the cancellation determination of operation requests by the vehicle API 85 of the first ECU 10, as well as in the cancellation determination of operation requests by the state recognition unit 81 of the third ECU 20.

The stored request deletion unit 181 deletes the operation request determined to be canceled by the stored request cancellation determination unit 74 from the first queue 88. Furthermore, the stored request deletion unit 181 notifies the application execution unit that is the source of the operation request that the operation request has been canceled, based on the identification information included in the canceled operation request.

The transmission unit 75 sends the operation request determined not to be canceled by the stored request cancellation determination unit 74 to the third ECU 20.

The reception unit 76 receives the operation request and the corresponding first cancellation condition from the transmission unit 75. The request arbitration unit 77 stores the operation request in the second queue 89 each time the reception unit 76 receives an operation request. The operation requests stored in the second queue 89 are in an arbitration waiting state (i.e., execution waiting state). The request arbitration unit 77 arbitrates among multiple competing operation requests in the second queue 89. Competing operation requests are operation requests related to the same target equipment. The request arbitration unit 77 stores multiple operation requests in the second queue 89 in the priority order set according to the arbitration rules.

For example, one example of multiple competing operation requests is multiple operation requests related to the camera. Multiple operation requests related to the camera include high-resolution shooting on, low-resolution shooting on, shooting off, etc. Another example of multiple competing operation requests is multiple operation requests related to the front light. Multiple operation requests related to the front light include low beam on, high beam on, flashing for 10 seconds, off, etc.

The request arbitration unit 77 stores the first cancellation condition in association with the operation request. The request arbitration unit 77 obtains and stores the second cancellation condition associated with the operation request from the vehicle API 85 in advance. Therefore, the request arbitration unit 77 stores the first cancellation condition and the second cancellation condition in association with the operation request.

The vehicle state determination unit 78 determines the state of the vehicle.

The arbitration waiting request cancellation determination unit 79 determines whether to cancel the operation request based on the vehicle state determined by the vehicle state determination unit 78 and the first cancellation condition and the second cancellation condition corresponding to the operation request stored in the second queue 89. The arbitration waiting request cancellation determination unit 79 executes the cancellation determination when the arbitration waiting state ends. Alternatively, the arbitration waiting request cancellation determination unit 79 may execute the cancellation determination during the arbitration waiting state of the operation request. When executing the cancellation determination during the arbitration waiting state of the operation request, the arbitration waiting request cancellation determination unit 79 may execute the cancellation determination only once or periodically.

The arbitration waiting request deletion unit 182 deletes the operation request determined to be canceled by the arbitration waiting request cancellation determination unit 79 from the second queue 89.

The arbitration waiting request cancellation determination unit 79 sends the operation request determined not to be canceled to the operation control unit 80. In this embodiment, the camera control unit 91 of the sixth ECU 41 or the millimeter-wave control unit 92 of the seventh ECU 42 includes the operation control unit 80. The operation control unit 80 receives the operation request and operates the target equipment.

As described above, in the vehicle control system 1 according to an example of this embodiment, the first ECU 10 determines whether to cancel the operation request based on the first cancellation condition and the second cancellation condition. The third ECU 20 determines whether to cancel the operation request based on the first cancellation condition and the second cancellation condition for the operation request that the first ECU 10 determined not to cancel. Although the vehicle control system 1 according to an example of this embodiment executes the cancellation determination of the operation request twice, the number of times the cancellation determination is executed is not limited to two.

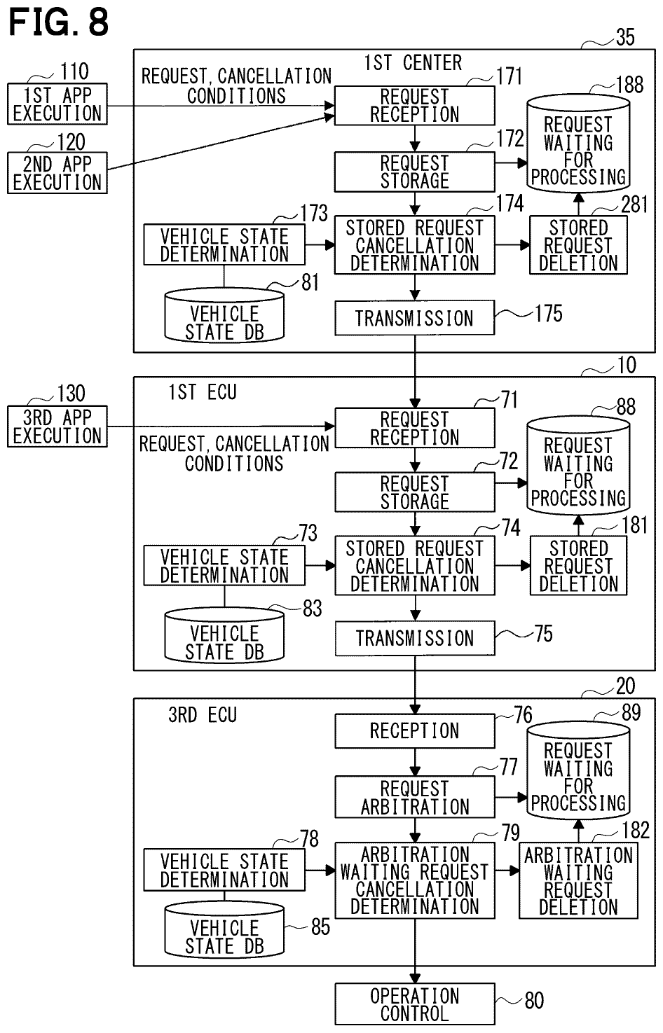

FIG. 7 shows a schematic configuration of a vehicle control system 1 according to another example of this embodiment. In the vehicle control system 1 shown in FIG. 7, the fourth ECU 25, the fifth ECU 30, and the sixth to thirteenth ECUs 41 to 48 are omitted from the illustration. As shown in FIG. 7, the vehicle control system 1 according to another example of this embodiment includes a first center 35 instead of the center 35, and additionally includes a second center 145. The first center 35 includes a center API 135, and the second center 145 includes a first application execution unit 110 and a second application execution unit 120. Additionally, the second ECU 15 includes a third application execution unit 130.

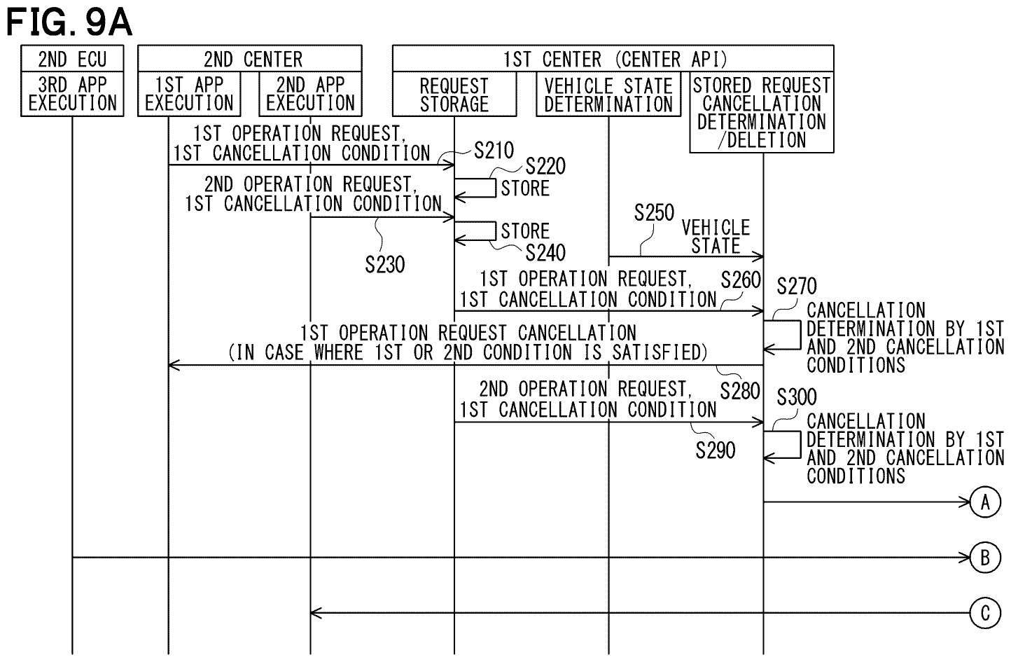

As shown in FIG. 8, in the vehicle control system 1 according to another example of this embodiment, the center API 135 includes the functions of a request reception unit 171, a request storage unit 172, a vehicle state determination unit 173, a stored request cancellation determination unit 174, a transmission unit 175, a stored request deletion unit 281, a vehicle state DB 81, and a queue 188. The request reception unit 171, request storage unit 172, vehicle state determination unit 173, stored request cancellation determination unit 174, transmission unit 175, stored request deletion unit 281, and queue 188 have functions similar to those of the request reception unit 71, request storage unit 72, vehicle state determination unit 73, stored request cancellation determination unit 74, transmission unit 75, stored request deletion unit 181, and first queue 88, respectively.

Additionally, in the vehicle control system 1 according to another example of this embodiment, the first ECU 10 further includes a vehicle state DB 83, and the third ECU 20 further includes a vehicle state DB 85. The vehicle state DB 81 of the first center 35 stores vehicle data received from multiple vehicles via the communication unit 37, linked with vehicle IDs. The vehicle state DBs 83 and 85 of the first and third ECUs 10 and 20 store vehicle data of the vehicles in which the first and third ECUs 10 and 20 are mounted.

The request reception unit 171 of the first center 35 receives operation requests and corresponding first cancellation conditions from the first application execution unit 65 and the second application execution unit 66 of the second center 140. The vehicle state determination unit 173 of the first center 35 acquires vehicle data of the vehicle in which the first ECU 10 is mounted from the vehicle data stored in the vehicle state DB 81 and determines the vehicle state based on the acquired vehicle data. The transmission unit 175 of the first center 35 sends the operation requests determined not to be canceled by the stored request cancellation determination unit 174 and the corresponding first cancellation conditions to the first ECU 10.

The request reception unit 71 of the first ECU 10 receives the operation requests determined not to be canceled and the corresponding first cancellation conditions from the first center 35. Additionally, the request reception unit 71 receives operation requests and corresponding first cancellation conditions from the third application execution unit 130 of the second ECU 15. The vehicle state determination unit 73 determines the state of the vehicle based on the vehicle data stored in the vehicle state DB 83. The communication unit 75 sends the operation requests determined not to be canceled by the stored request cancellation determination unit 74 and the corresponding first cancellation conditions to the third ECU 20.

The reception unit 76 of the third ECU 20 receives the operation requests determined not to be canceled and the corresponding first cancellation conditions from the first ECU 10. The vehicle state determination unit 78 determines the state of the vehicle based on the vehicle data stored in the vehicle state DB 85. Note that one of the vehicle state DBs 83 and 85 may be deleted, and the first and third ECUs 10 and 20 may refer to the remaining vehicle data of the other vehicle state DB.

In the vehicle control system 1 according to another example of this embodiment, operation requests are sent from the second center 140 to the third ECU 20 via the first center 35 and the first ECU 10. The first center 35 receives operation requests from various application execution units other than the first and second application execution units 110 and 120. Therefore, a large number of operation requests are stored in the queue 188, and the state of the vehicle may change while the operation requests received from the first and second application execution units 110 and 120 are in a processing waiting state. Accordingly, before sending the operation requests from the first center 35 to the first ECU 10, the first center 35 determines whether to cancel the operation requests. That is, in the vehicle control system 1 according to another example of this embodiment, the first center 35, in addition to the first ECU 10 and the third ECU 20, also determines whether to cancel the operation requests. In the vehicle control system 1 according to another example of this embodiment, the cancellation determination is executed three times.

Additionally, instead of the state recognition unit 81, any of the motion system equipment control unit 82, the HMI system state recognition unit 83, or the body system control unit 84 may include the functions of the reception unit 76, the request arbitration unit 77, the vehicle state determination unit 78, the arbitration waiting request cancellation determination unit 79, and the second queue 89. If the motion system equipment control unit 82 includes these functions instead of the state recognition unit 81, the first ECU 10 includes all the functions of the request reception unit 71, the request storage unit 72, the vehicle state determination unit 73, the stored request cancellation determination unit 74, the transmission unit 75, the first queue 88, the reception unit 76, the request arbitration unit 77, the vehicle state determination unit 78, the arbitration waiting request cancellation determination unit 79, and the second queue 89. Alternatively, the center 35 may include all the functions of the request reception unit 71, the request storage unit 72, the vehicle state determination unit 73, the stored request cancellation determination unit 74, the transmission unit 75, the first queue 88, the reception unit 76, the request arbitration unit 77, the vehicle state determination unit 78, the arbitration waiting request cancellation determination unit 79, and the second queue 89.

Additionally, in another example of the vehicle control system 1 shown in FIG. 7, the first center 35 may further include the functions of the reception unit 76, the request arbitration unit 77, the vehicle state determination unit 78, the arbitration waiting request cancellation determination unit 79, and the second queue 89 instead of the state recognition unit 81. In this case, the arbitration waiting request cancellation determination unit 79 of the first center 35 sends the operation requests determined not to be canceled to the vehicle API 85.

### 2. Processing

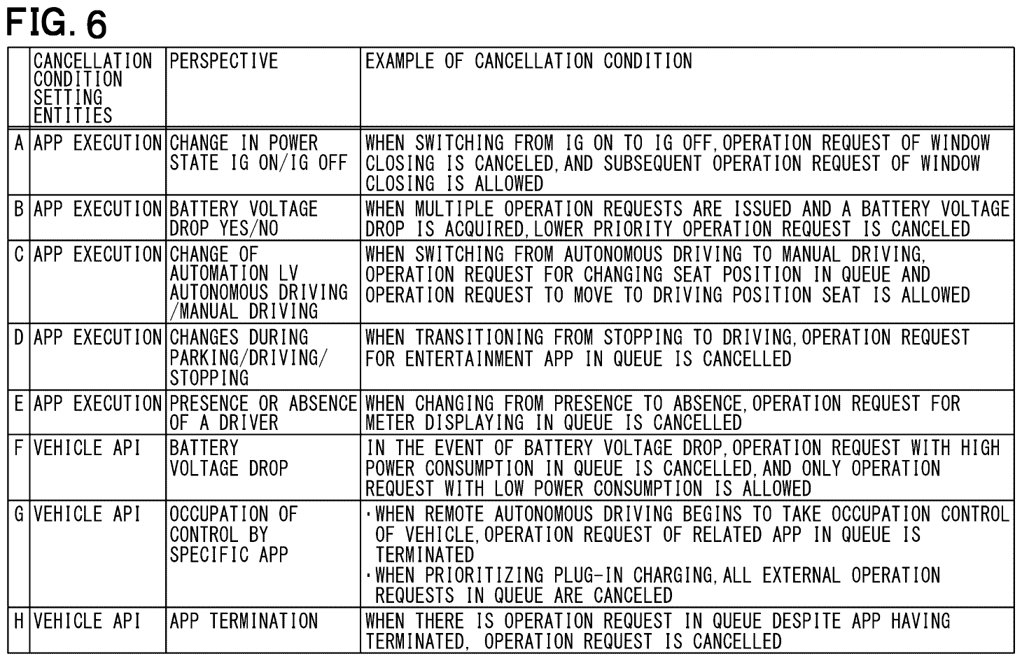

Referring to the sequence diagram in FIG. 5, the control processing executed by an example of the vehicle control system 1 shown in FIG. 1 will be described.

In S10, the first application execution unit 63 sends the first operation request and the corresponding first cancellation condition to the first ECU 10. Subsequently, in S20, the request storage unit 72 stores the first cancellation condition in association with the first operation request and stores the first operation request in the first queue 88.

Subsequently, in S30, the second application execution unit 64 sends the second operation request and the corresponding first cancellation condition to the first ECU 10. Subsequently, in S40, the request storage unit 72 stores the first cancellation condition in association with the second operation request and stores the second operation request in the first queue 88.

Subsequently, in S50, the vehicle state determination unit 73 determines the state of the vehicle and sends the determined vehicle state to the stored request cancellation determination unit 74. The stored request cancellation determination unit 74 stores the received vehicle state.

Subsequently, in S60, the request storage unit 72 sends the first operation request, which has finished its processing waiting state, and the corresponding first cancellation condition to the stored request cancellation determination unit 74. Note that the request storage unit 72 may send the first operation request and the corresponding first cancellation condition to the stored request cancellation determination unit 74 at the set time (e.g., X seconds after reception) or periodically during the processing waiting state.

Subsequently, in S70, the stored request cancellation determination unit 74 determines whether to cancel the first operation request based on the received vehicle state, the first cancellation condition, and the second cancellation condition set and stored by the vehicle API 85.

In S80, the stored request cancellation determination unit 74 determines to cancel the first operation request based on the first cancellation condition or the second cancellation condition being satisfied. The stored request deletion unit 181 deletes the first operation request from the first queue 88 and notifies the first application execution unit 63 that the first operation request has been canceled.

Subsequently, in S90, the request storage unit 72 sends the second operation request, which has finished its processing waiting state, and the corresponding first cancellation condition to the stored request cancellation determination unit 74. Note that the request storage unit 72 may send the second operation request and the corresponding first cancellation condition to the stored request cancellation determination unit 74 at the set time (e.g., Y seconds after reception) or periodically during the processing waiting state.

Subsequently, in S100, the stored request cancellation determination unit 74 determines whether to cancel the second operation request based on the received vehicle state, the first cancellation condition, and the second cancellation condition.

In S110, if the first cancellation condition and the second cancellation condition are not satisfied, the stored request cancellation determination unit 74 sends the second operation request and the corresponding first cancellation condition to the request arbitration unit 77. The request arbitration unit 77 stores the first cancellation condition in association with the second operation request and stores the second operation request in the second queue 89.

In S120, the request arbitration unit 77 arbitrates between the second operation request and competing operation requests stored in the second queue 89. The arbitration sets the priority order of multiple competing operation requests in the second queue 89 according to the arbitration rules set by the vehicle API 85 and/or the application execution unit. The arbitration rules, for example, set the priority for each operation request based on the vehicle state. The arbitration waiting state corresponds to the period during which an operation request is not immediately executed due to the set priority until it becomes executable.

In S130, the request arbitration unit 77 sends the second operation request and the corresponding first cancellation condition to the arbitration waiting request cancellation determination unit 79 when the arbitration waiting state of the second operation request ends.

Subsequently, in S140, the arbitration waiting request cancellation determination unit 79 determines whether to cancel the second operation request based on the acquired vehicle state, the first cancellation condition, and the second cancellation condition.

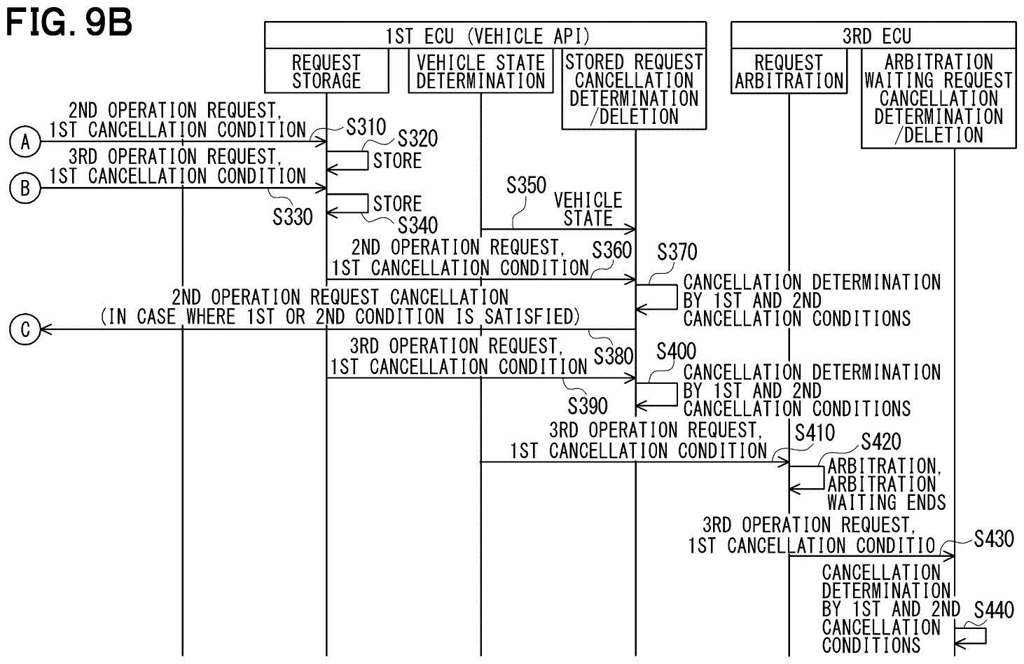

Next, referring to the sequence diagrams in FIG. 9A and FIG. 9B, the control processing executed by another example of the vehicle control system 1 shown in FIG. 7 will be described.

In S210, the first application execution unit 110 of the second center 140 executes the same processing as in S10. Subsequently, in S220, the request storage unit 172 of the first center 35 executes the same processing as in S20.

Subsequently, in S230, the second application execution unit 120 of the second center 140 executes the same processing as in S30. Subsequently, in S240, the request storage unit 172 of the first center 35 executes the same processing as in S40.

Subsequently, in S250, the vehicle state determination unit 173 of the first center 35 executes the same processing as in S50. Subsequently, in S260, the request storage unit 172 of the first center 35 executes the same processing as in S60. Subsequently, in S270, the stored request cancellation determination unit 174 of the first center 35 executes the same processing as in S70.

Subsequently, in S280, the stored request cancellation determination unit 174 of the first center 35 determines to cancel the first operation request. The stored request deletion unit 281 of the first center 35 deletes the first operation request from the queue 188 and notifies the first application execution unit 110 of the second center 140 that the first operation request has been canceled.

Subsequently, in S290, the request storage unit 172 of the first center 35 executes the same processing as in S90. Subsequently, in S300, the stored request cancellation determination unit 174 of the first center 35 executes the same processing as in S100.

Subsequently, in S310, the stored request cancellation determination unit 174 of the first center 35 determines not to cancel the second operation request and sends the second operation request and the corresponding first cancellation condition to the first ECU 10.

Subsequently, in S320, the request storage unit 72 of the first ECU 10 executes the same processing as in S20. Subsequently, in S330, the third application execution unit 130 of the second ECU 15 sends the third operation request and the corresponding first cancellation condition to the first ECU 10. Subsequently, in S340, the request storage unit 72 of the first ECU 10 executes the same processing as in S40.

Subsequently, in S350, the vehicle state determination unit 73 of the first ECU 10 executes the same processing as in S50. Subsequently, in S360, the request storage unit 72 of the first ECU 10 executes the same processing as in S60. Subsequently, in S370, the stored request cancellation determination unit 74 of the first ECU 10 executes the same processing as in S70.

Subsequently, in S380, the stored request cancellation determination unit 74 of the first ECU 10 determines to cancel the second operation request. The stored request deletion unit 181 of the first ECU 10 deletes the second operation request from the first queue 88 and notifies the second application execution unit 120 of the second center 140 that the second operation request has been canceled.

Subsequently, in S390, the request storage unit 72 of the first ECU 10 executes the same processing as in S90. Subsequently, in S400, the stored request cancellation determination unit 74 of the first ECU 10 executes the same processing as in S100. Subsequently, in S410, the stored request cancellation determination unit 74 of the first ECU 10 determines not to cancel the third operation request and sends the third operation request and the corresponding first cancellation condition to the third ECU 20. The request arbitration unit 77 of the third ECU 20 stores the first cancellation condition in association with the third operation request and stores the third operation request in the second queue 89.

Subsequently, in S420 and S430, the request arbitration unit 77 of the third ECU 20 executes the same processing as in S120 and S130. Subsequently, in S440, the arbitration waiting request cancellation determination unit 79 of the third ECU 20 executes the same processing as in S140.

Additionally, in another example of the vehicle control system 1 according to this embodiment, the first center 35 includes the functions of the reception unit 76, the request arbitration unit 77, the vehicle state determination unit 78, the arbitration waiting request cancellation determination unit 79, and the second queue 89. In this case, in the sequence diagram shown in FIG. 5, the second center 140 executes the processing of S10 and S30, and the first center 35 executes the processing of S20 and S40 to S140.

### 3. Effects

According to the first embodiment described in detail above, the following effects are achieved.

(1) The request reception unit 71 receives the operation request and the first cancellation condition. The stored request cancellation determination unit 74 determines whether to cancel the operation request stored in the first queue 88 based on the vehicle state, the first cancellation condition, and the second cancellation condition when the waiting state of the operation request in the first queue 88 ends. Therefore, it is possible to avoid executing operation requests that have become unnecessary during the waiting state. Consequently, vehicle control that does not cause discomfort to the user can be realized.

(2) The first cancellation condition is set by the application execution unit (i.e., the application creator, including third parties) to ensure user convenience. The second cancellation condition is set by the vehicle API 85 (i.e., the platform provider) to ensure vehicle safety by forcibly canceling the operation request. By executing the cancellation determination of the operation request according to the first cancellation condition, operation requests that have missed their execution timing are immediately canceled. Additionally, by executing the cancellation determination of the operation request according to the second cancellation condition, operation requests are canceled even in vehicle states not set by the application execution unit as cancellation conditions. In other words, by executing the cancellation determination of the operation request according to the two cancellation conditions set from the perspectives of the application creator and the platform provider, both convenience and safety can be ensured.

(3) Since the first cancellation condition includes conditions related to the vehicle state, it is determined whether to cancel the operation request stored in the first queue 88 based on the vehicle state. Therefore, it is possible to avoid executing operation requests that have become unnecessary for the vehicle state.

(4) There is a possibility that the vehicle state may change during the arbitration waiting state of the operation request. When the operation request transitions from the arbitration waiting state to the executable state, it is determined again whether to cancel the operation request based on the vehicle state, the first cancellation condition, and the second cancellation condition. This appropriately avoids executing operation requests that have become unnecessary during the arbitration waiting state.

(5) The cancellation determination of the operation request is executed by both the stored request cancellation determination unit 74 and the arbitration waiting request cancellation determination unit 79. If the cancellation determination of the operation request is executed only by the stored request cancellation determination unit 74, the vehicle state may change between the time it is determined not to cancel the operation request and the end of the arbitration waiting state, making the operation request unnecessary or impossible. In other words, it is possible to execute unnecessary or impossible operation requests. If the cancellation determination of the operation request is executed only by the arbitration waiting request cancellation determination unit 79, operation requests that have already become unnecessary or impossible are stored in the second queue 89, and arbitration with other operation requests is executed. Therefore, unnecessary arbitration is executed, increasing the processing load. By executing the cancellation determination of the operation request by both the stored request cancellation determination unit 74 and the arbitration waiting request cancellation determination unit 79, it is possible to avoid executing unnecessary or impossible operation requests and suppress the processing load.

(6) The first and second application execution units 61 to 66 select from multiple preset abstracted vehicle states as the first cancellation condition and set the conditions for the selected vehicle state. Therefore, third parties who are not familiar with the vehicle can easily develop applications and specify the first cancellation condition.

### Other Embodiments

While the embodiments of the present disclosure have been described above, the present disclosure is not limited to the above-described embodiments and can be implemented in various modified forms.

(a) The microcomputers 11, 36 and their methods described in the present disclosure may be realized by a dedicated computer provided by configuring a processor and memory programmed to execute one or more functions embodied by a computer program. Alternatively, the microcomputers 11, 36 and their methods described in the present disclosure may be realized by a dedicated computer provided by configuring a processor with one or more dedicated hardware logic circuits. Or, the microcomputers 11, 36 and their methods described in the present disclosure may be realized by one or more dedicated computers configured by a combination of a processor and memory programmed to execute one or more functions and one or more hardware logic circuits. Additionally, the computer program may be stored as instructions executable by a computer on a computer-readable non-transitory tangible storage medium. The methods for realizing the functions of each part included in the microcomputers 11, 36 do not necessarily need to include software, and all the functions may be realized using one or more hardware components.

(b) The multiple functions possessed by one component in the above embodiments may be realized by multiple components, or one function possessed by one component may be realized by multiple components. Additionally, the multiple functions possessed by multiple components may be realized by one component, or one function realized by multiple components may be realized by one component. Furthermore, some parts of the configuration of the above embodiments may be omitted. Additionally, at least part of the configuration of the above embodiments may be added to or replaced with the configuration of other embodiments described above.

(c) In addition to the onboard device and the center device described above, the present disclosure can also be realized in various forms such as a system including the onboard device and the center device as components, a program for making a computer function as the onboard device or the center device, a non-transitory tangible storage medium such as a semiconductor memory recording the program, and a vehicle control method.

What is claimed is:

1. An onboard device mounted on a vehicle, comprising:
a request acceptance unit configured to receive an operation request for the vehicle according to execution of application software and a first cancellation condition, which is a condition for canceling the operation request, from an application execution unit configured to execute the application software;
a request storage unit configured to store the operation request received by the request acceptance unit in a first queue;
a stored request cancellation determination unit configured to determine whether to cancel the operation request stored in the first queue according to the first cancellation condition received by the request acceptance unit and a second cancellation condition, which is a preset condition related to usage of the vehicle, for canceling the operation request; and
a stored request deletion unit configured to delete the operation request from the first queue when the stored request cancellation determination unit determines that the operation request is to be canceled.

2. The onboard device according to claim 1, wherein
the first cancellation condition includes a condition related to a state of the vehicle.

3. The onboard device according to claim 1, further comprising:
a request arbitration unit configured to store the operation request, which is determined not to be canceled by the stored request cancellation determination unit, in a second queue and to arbitrate between the operation request and a competing request stored in the second queue;
an arbitration waiting request cancellation determination unit configured to determine whether to cancel the operation request according to the first cancellation condition and the second cancellation condition; and
an arbitration waiting request deletion unit configured to delete the operation request from the second queue when the arbitration waiting request cancellation determination unit determines that the operation request is to be canceled.

4. The onboard device according to claim 3, wherein
the application execution unit is configured to select a vehicle state from a plurality of preset abstracted vehicle states as the first cancellation condition and to set the condition for the selected vehicle state.

5. The onboard device according to claim 3, wherein
the onboard device includes a first device and a second device,
the first device includes the request acceptance unit, the request storage unit, the stored request cancellation determination unit, and the stored request deletion unit, and
the second device includes the request arbitration unit, the arbitration waiting request cancellation determination unit, and the arbitration waiting request deletion unit.

6. A center device configured to communicate wirelessly with a vehicle, comprising:
a request acceptance unit configured to receive an operation request for the vehicle according to execution of application software and a first cancellation condition, which is a condition for canceling the operation request, from an application execution unit configured to execute the application software;
a request storage unit configured to store the operation request received by the request acceptance unit in a first queue;
a stored request cancellation determination unit configured to determine whether to cancel the operation request stored in the first queue according to the first cancellation condition received by the request acceptance unit and a second cancellation condition, which is a preset condition related to usage of the vehicle, for canceling the operation request; and
a stored request deletion unit configured to delete the operation request from the first queue when the stored request cancellation determination unit determines that the operation request is to be canceled.

7. The center device according to claim 6, wherein
the first cancellation condition includes a condition related to a state of the vehicle.

8. The center device according to claim 6, further comprising:
a request arbitration unit configured to store the operation request, which is determined not to be canceled by the stored request cancellation determination unit, in a second queue and to arbitrate between the operation request and a competing request stored in the second queue;
an arbitration waiting request cancellation determination unit configured to determine whether to cancel the operation request according to the first cancellation condition and the second cancellation condition; and
an arbitration waiting request deletion unit configured to delete the operation request from the second queue when the arbitration waiting request cancellation determination unit determines that the operation request is to be canceled.

9. The center device according to claim 8, wherein
the application execution unit is configured to select a vehicle state from a plurality of preset abstracted vehicle states as the first cancellation condition and to set the condition for the selected vehicle state.

10. A non-transitory computer readable storage medium storing a vehicle control program for causing a processing device to execute:
receiving an operation request for a vehicle according to execution of application software and a first cancellation condition, which is a condition for canceling the operation request, from an application execution unit configured to execute the application software;
storing the received operation request in a queue;
determining whether to cancel the operation request stored in the queue according to the first cancellation condition and a second cancellation condition, which is a preset condition related to usage of the vehicle, for canceling the operation request; and
deleting the operation request from the queue when it is determined that the operation request is to be canceled.

11. A vehicle control method executed by a processing device, comprising:
receiving an operation request for a vehicle according to execution of application software and a first cancellation condition, which is a condition for canceling the operation request, from an application execution unit configured to execute the application software;
storing the received operation request in a queue;
determining whether to cancel the operation request stored in the queue according to the first cancellation condition and a second cancellation condition, which is a preset condition related to usage of the vehicle, for canceling the operation request; and
deleting the operation request from the queue when it is determined that the operation request is to be canceled.

12. A non-transitory computer readable storage medium storing a vehicle control program for causing a center device configured to communicate wirelessly with a vehicle to execute:
receiving an operation request for the vehicle according to execution of application software and a first cancellation condition, which is a condition for canceling the operation request, from an application execution unit configured to execute the application software;
storing the received operation request in a queue;
determining whether to cancel the operation request stored in the queue according to the first cancellation condition and a second cancellation condition, which is a preset condition related to usage of the vehicle, for canceling the operation request; and
deleting the operation request from the queue when it is determined that the operation request is to be canceled.

13. A vehicle control method executed by a center device configured to communicate wirelessly with a vehicle, comprising:
receiving an operation request for the vehicle according to execution of application software and a first cancellation condition, which is a condition for canceling the operation request, from an application execution unit configured to execute the application software;
storing the received operation request in a queue;
determining whether to cancel the operation request stored in the queue according to the first cancellation condition and a second cancellation condition, which is a preset condition related to usage of the vehicle, for canceling the operation request; and
deleting the operation request from the queue when it is determined that the operation request is to be canceled.

14. A vehicle control system comprising:
a first onboard device and a second onboard device mounted on a vehicle; and
a center device configured to communicate wirelessly with the first onboard device,
wherein
the center device includes:
a first request acceptance unit configured to receive an operation request for the vehicle according to execution of first application software and a first cancellation condition, which is a condition for canceling the operation request, from a first application execution unit configured to execute the first application software;
a first request storage unit configured to store the operation request received by the first request acceptance unit in a first queue;
a first stored request cancellation determination unit configured to determine whether to cancel the operation request stored in the first queue according to the first cancellation condition received by the first request acceptance unit and a second cancellation condition, which is a preset condition related to usage of the vehicle, for canceling the operation request; and
a first stored request deletion unit configured to delete the operation request from the first queue when the first stored request cancellation determination unit determines that the operation request is to be canceled,
the first onboard device includes:
a second request acceptance unit configured to receive the operation request and the first cancellation condition determined not to be canceled by the first stored request cancellation determination unit;
a second request storage unit configured to store the operation request received by the second request acceptance unit in a second queue;
a second stored request cancellation determination unit configured to determine whether to cancel the operation request stored in the second queue according to the first cancellation condition received by the second request acceptance unit and a preset second cancellation condition; and
a second stored request deletion unit configured to delete the operation request from the second queue when the second stored request cancellation determination unit determines that the operation request is to be canceled,
the second onboard device includes:
a request arbitration unit configured to store the operation request, which is determined not to be canceled by the second stored request cancellation determination unit, in a third queue and to arbitrate between the operation request and a competing request stored in the third queue;
an arbitration waiting request cancellation determination unit configured to determine whether to cancel the operation request according to the first cancellation condition and the second cancellation condition; and
an arbitration waiting request deletion unit configured to delete the operation request from the third queue when it is determined by the arbitration waiting request cancellation determination unit that the operation request is to be canceled.

15. The vehicle control system according to claim 14, wherein
the second request acceptance unit is configured to receive the operation request for the vehicle according to execution of second application software and the corresponding first cancellation condition from a second application execution unit configured to execute the second application software.

16. A vehicle control method executed by a system comprising a first onboard device and a second onboard device mounted on a vehicle, and a center device configured to communicate wirelessly with the first onboard device, the method comprising:
in the center device:
receiving an operation request for the vehicle according to execution of first application software and a first cancellation condition, which is a condition for canceling the operation request, from a first application execution unit configured to execute the first application software;
storing the received operation request in a first queue;
determining whether to cancel the operation request stored in the first queue according to the first cancellation condition received and a second cancellation condition, which is a preset condition related to usage of the vehicle, for canceling the operation request;
deleting the operation request from the first queue when it is determined that the operation request is to be canceled;
in the first onboard device:
receiving the operation request and the first cancellation condition determined not to be canceled by the center device;
storing the received operation request in a second queue;
determining whether to cancel the operation request stored in the second queue according to the first cancellation condition received and a preset second cancellation condition;
deleting the operation request from the second queue when it is determined that the operation request is to be canceled;
in the second onboard device:
receiving the operation request determined not to be canceled by the first onboard device and storing it in a third queue;
arbitrating between the operation request and a competing request stored in the third queue;
determining whether to cancel the operation request according to the first cancellation condition and the second cancellation condition; and
deleting the operation request from the third queue when it is determined that the operation request is to be canceled.
